(19) United States
(12) Patent Application Publication
(10) Pub. No.: US 2013/0314913 A1
(43) Pub. Date: Nov. 28, 2013

(54) LIGHT DISPERSING DEVICE

(71) Applicant: Chung-Ming LEE, Taichung City (TW)

(72) Inventor: Chung-Ming LEE, Taichung City (TW)

(21) Appl. No.: 13/477,375

(22) Filed: May 22, 2012

(51) Int. Cl. F21V 7/22

(52) U.S. Cl. 362/235; 362/296.01

(57) ABSTRACT

A light dispersing device mainly includes plural light transmissive plates and plural luminous bodies. Each light transmissive plate has at least two inclined sections, a middle section, and two extending sections. The inclined sections extend respectively from two ends of the middle section outwardly and inclinedly, and further connect to extending sections. The middle section has a first surface and a second surface. At least one of the first and the second surfaces is formed with a light reducing layer. The luminous bodies face to middle sections of corresponding light transmissive plates respectively. As such, linear light sources of each luminous are blocked and weakened by the light reducing layer, and a part of the light sources are reflected simultaneously along the inclined sections to extending sections. Thus the light sources are evenly dispersed outwardly.

### BACKGROUND OF THE INVENTION

1. Field of the Invention

The present invention relates to a light dispersing device, and more particularly to a light dispersing device generates light sources which direct go through a light transmissive plate so that the light sources are weakened and softened by the light transmissive plate outwardly.

2. Description of the Prior Art

The power consumption of light-emitting diode (LED) is so low that may economize source of energy. Many countries dedicate to develop and improve the realm of LED. Although LED has environmental protection property, the light sources generated by LED are linear so that they are unable to illuminate larger area. Not only that, but the intensities of light sources are so strong that may excite and harm eyes as the LED serves as decoration or illumination.

To overcome said disadvantages of linear light sources of LED, manufacturers adopt lateral light sources with a diffusion plate so that the light sources of LED indirect illuminate outwardly and diffuse into soft surface light sources. Nevertheless, the manner mainly emphasizes for indirect illuminating light source. With regard to light sources of LED direct goes through a light transmissive surface perpendicularly, no one brings up ideal manners for resolving the said problem so far. Additionally, when light sources of LED direct illuminate outwardly, some part of illuminated area of the light is bright (the bright area which is illuminated direct by the light of LED), and some part of that is dark, i.e. the light sources are uncoordinated.

The present invention is, therefore, arisen to obviate or at least mitigate the above mentioned disadvantages.

### SUMMARY OF THE INVENTION

The main object of the present invention is to provide a light dispersing device which has at least a light transmissive plate and at least a LED luminous body. Light sources of the LED luminous body direct go through light transmissive plate and turn into soft and even light sources.

To achieve the above and other objects, a light dispersing device of the present invention comprises at least a light transmissive plate and at least a luminous body.

The light transmissive plate comprises two inclined sections, a middle section and two extending sections. The inclined sections extend respectively from two ends of middle section outwardly and inclinedly. The extending sections extend respectively from one end of one of the inclined sections where is away from the middle section laterally. The middle section is located between the extending sections.

Wherein the middle section has a first surface and a second surface. At least one of the first and the second surfaces is formed with a light reducing layer. The light reducing layer has properties of weakening the intensities of light sources and reflecting light sources.

The light-emitting diode luminous body is located at one side of the light transmissive plate and faces to the middle section of the light transmissive plate. An axis of the luminous body is perpendicular to the middle section of the light transmissive plate.

When light sources of the luminous body illuminating the middle section of the light transmissive plate perpendicularly. The intensities of light sources are weakened by the light reducing layer, and a part of light sources are reflected along the inclined sections to the extending sections. Whereby the light sources are evenly dispersed outwardly.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a three dimensional view of the present invention;

FIG. 2 is a breakdown drawing of the present invention;

FIG. 3 is a partial cross sectional view of the present invention;

FIG. 3A is a partial enlargement drawing of FIG. 3;

FIG. 4 is a partial three dimensional view of the present invention;

FIG. 5 is a top view of FIG. 4;

FIG. 6 is a diagram showing light passing through a light transmissive plate.

### DETAILED DESCRIPTION OF THE PREFERRED EMBODIMENTS

A light dispersing device of the present invention is mainly used for installing in, but not limited to, an atomizer.

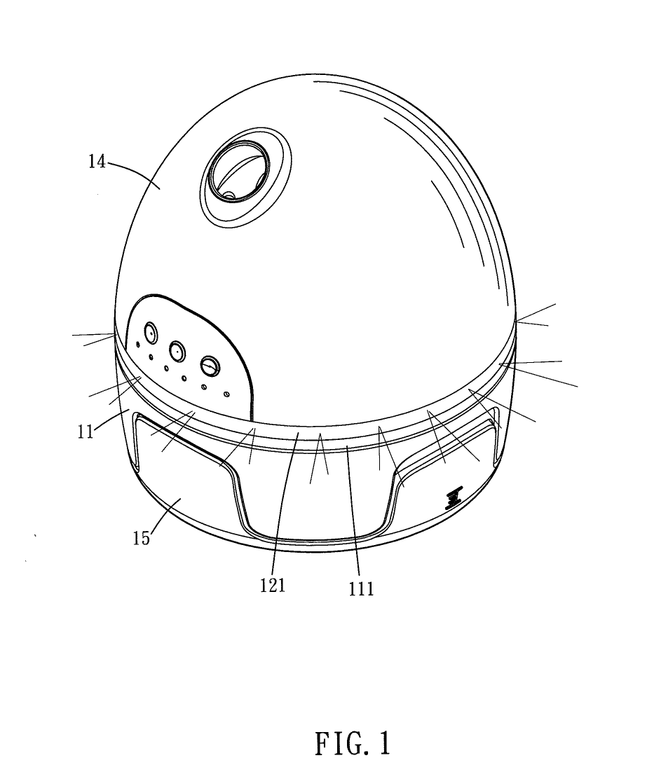

Please refer to FIG. 1 to FIG. 3, the atomizer includes a shell, a mist generating assembly and the light dispersing device.

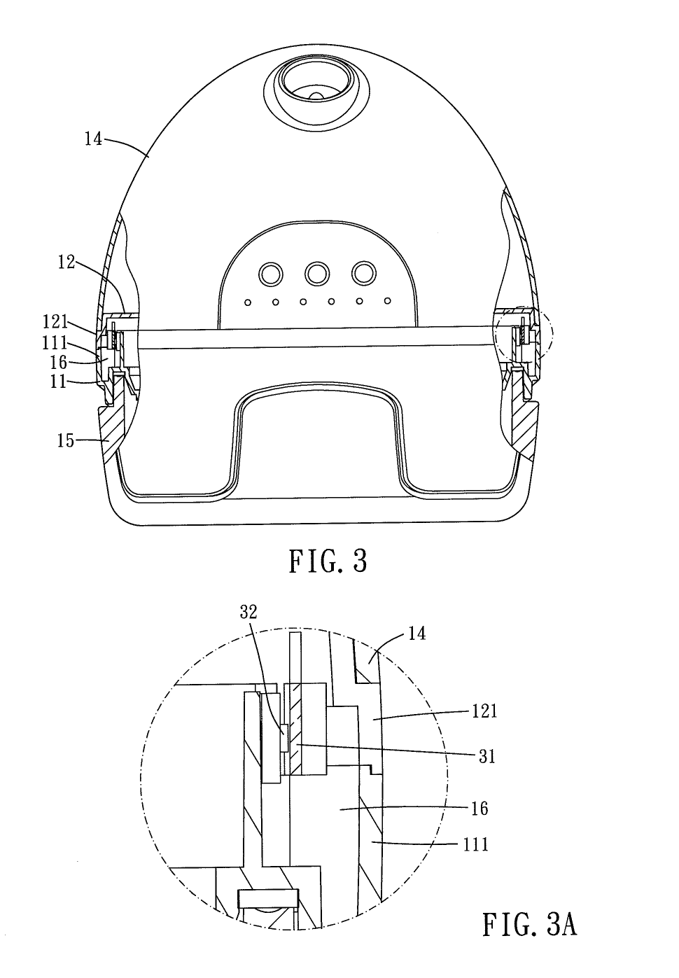

The shell includes a base 11, a laminate 12, a tank 13, and an outer housing 14. The shell further has a bottom housing 15 under the base 11. After assembling the bottom housing 15, the base 11, the laminate 12, the tank 13, and the outer housing 14 in turn, the shell to be completely installed, and the shell is formed with a receiving space therein. The receiving space further is divided into several rooms by the base 11, the laminate 12, and the tank 13. The laminate 12 is disposed on the base 11. The outer housing 14 is disposed on the laminate 12. The tank 13 is disposed on the laminate 12. The tank 13 and the room between the bottom housing 15 and the base 11 contain water.

Wherein an outer periphery of a top portion of the base 11 and an outer periphery of the laminate 12 define a luminous space 16, as shown in FIG. 3 and FIG. 3A. The luminous space 16, preferably, does not communicate with other rooms, i.e. the luminous space 16 is isolated from other rooms, so that water does not run into the luminous space 16 from other rooms. Wherein the outer periphery of the top of the base 11 is formed with a first annular light transmissive portion 111. The outer periphery of the laminate 12 is formed with a second annular light transmissive portion 121.

The mist generating assembly (as not shown) is disposed in the shell and used for producing and spraying mist to outside of the shell. The structure of the mist generating assembly is conventional in the art.

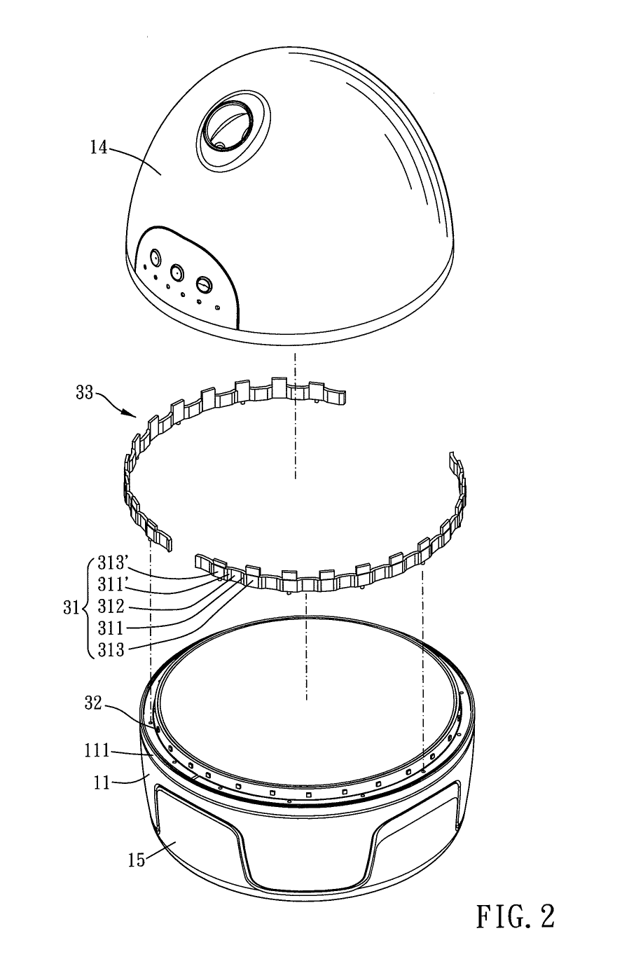

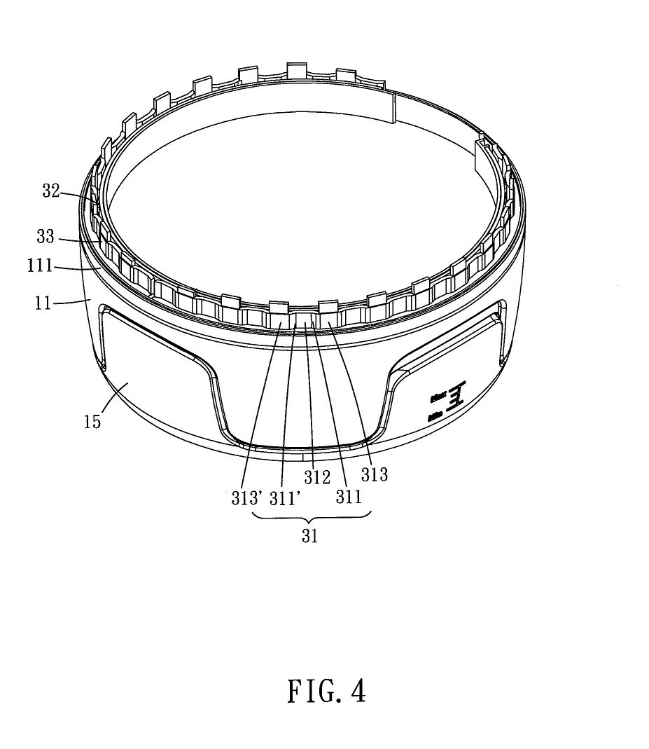

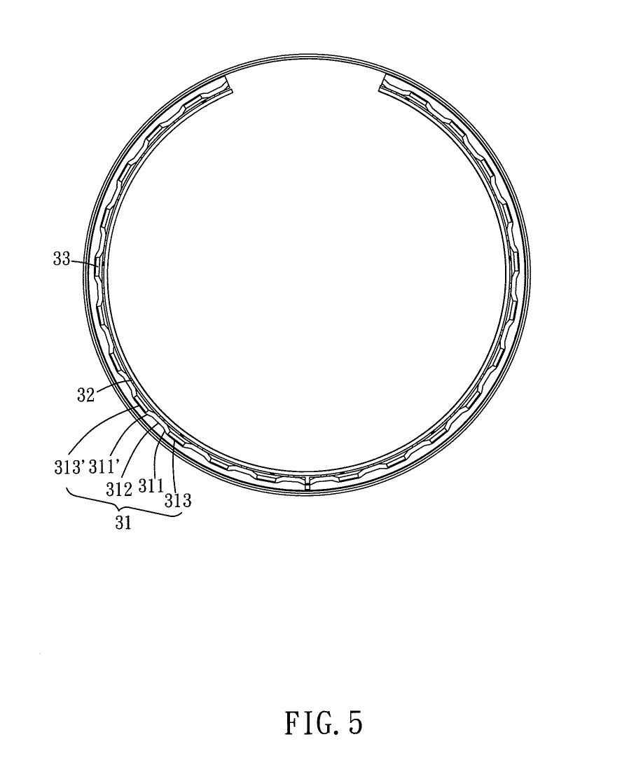

Please refer to FIG. 2 to FIG. 6, the light dispersing device is disposed in the shell, and more specifically in the luminous space 16, as shown in FIG. 3. The light dispersing device comprises a plurality of light transmissive plates 31 and a plurality of light-emitting diode luminous bodies 32. Each of light transmissive plates 31 at least comprises two inclined sections 311 and 311′, a middle section 312, and two extending sections 313 and 313′. The inclined sections 311 and 311′ extend respectively from two ends of middle section 312 inclinedly with respect to the middle section 312. Preferably, the inclined sections 311 and 311′ extend respectively from two ends of middle section 312 outwardly and inclinedly. The inclined sections 311 and 311′ further connect to extending sections which are adjacent to the middle section 312, that is to said the middle section 312 is located between the extending sections 313 and 313′. Extending directions of inclined sections 311 and 311′ are not parallel to each other. The middle section 312, which is a plane and the inclined sections 311 and 311′ define a concave recess. The concave recess gradually broadens outwardly so that it is tapered. The extending sections 313 and 313′ are planes and extend respectively from one end of one of the inclined sections 311 and 311′ where is away from the middle section 312 laterally. One of the extending sections 313 and 313′ of each light transmissive plate 31 connects to one of the inclined sections 311 and 311′ of another light transmissive plate, so that the luminous bodies 32 are spaced successively and formed with a light transmissive ring 33. The light transmissive ring 33 is disposed in the luminous space 16 annularly. The light transmissive plates are made of acrylic, plastic or PC (polycarbonate), etc. Preferably, the light transmissive plates 31 have flexibility, such that the light transmissive plates 31 are curved and circled to form the light transmissive ring 33.

The luminous bodies 32 are disposed annularly and spaced apart in the luminous space 16, and located at one side of the light transmissive ring 33. More specifically, the luminous bodies 32 are located at inside of the light transmissive ring 33. Each of luminous bodies 32 corresponds to one of the light transmissive plate 31. Wherein each of luminous bodies 32 faces to the middle section 312 of corresponding light transmissive plate 31, and an axis of each luminous body is perpendicular to the middle section 312 of corresponding light transmissive plate 31. In brief, each luminous body 32 direct faces to the middle section 312 of corresponding light transmissive plate 31, and selectively emits light sources A and B toward corresponding light transmissive plate 31. Preferably, each luminous body 32 is a single LED lamp. The LED lamps are spaced apart in the luminous space 16, and more preferably are disposed on a light strip and spaced apart to each other.

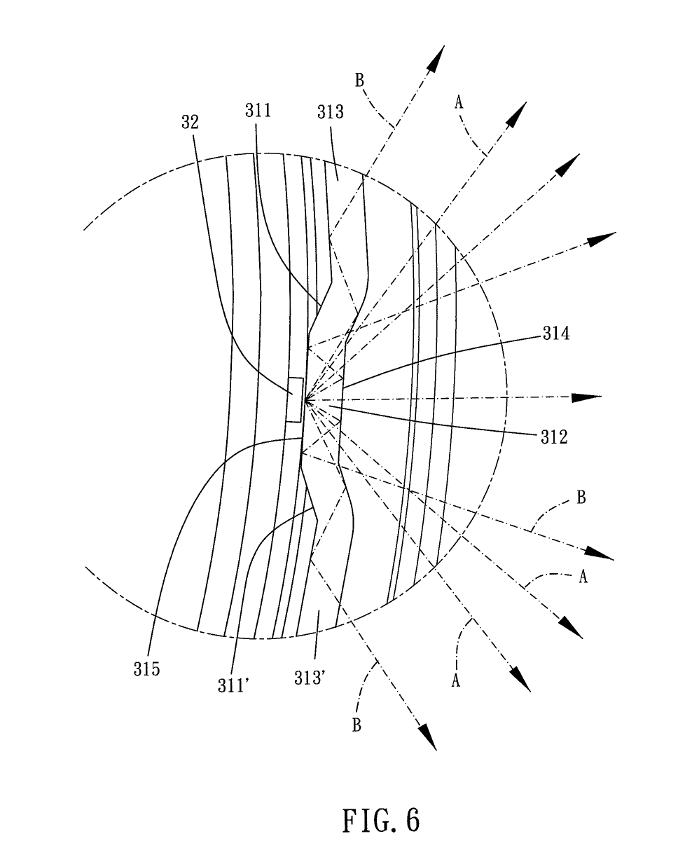

Please refer to FIG. 6, it is important that the middle section of each light transmissive plate 312 has a first surface 314 and a second surface 315. At least one of the first and the second surface 314 and 315 is formed with a light reducing layer (as not shown), wherein the light reducing layer formed on the first surface is the best choice. The light reducing layer has properties of weakening the intensity of light sources, reflecting light sources and evenly dispersing light sources. For example, a light diffusing agent possesses said properties so that it is appropriate as the light reducing layer. The light reducing layer is, but not limited to, a coating material, matte surface or a mask.

Please refer to FIG. 6, each of light transmissive plates has a proper thickness and transmittance. Each luminous body 32 emits a plurality of light sources A and B, some part of light sources A direct penetrate through the middle section 312, the inclined sections 311 and 311′, and the extending sections 313 and 313′, some part of light sources B are evenly dispersed by the light reducing layer and penetrates through the middle section 312, the inclined sections 311 and 311′, and the extending sections 313 and 313′. In the present embodiment, the first surface 314 of the middle section is formed with the light reducing layer, and the material of the light reducing layer in this embodiment can enhance the light reflectivity of the first surface 314 of the middle section. Enhancing the light reflectivity of the first surface 314 of the middle section is one of light source evenly dispersing means. After a part of light sources B pass through the second surface of the middle section, a part of light sources B are reflected at least once by the light reducing layer, afterwards a part of light sources are reflected at least once by the middle section 312, the inclined sections 311 and 311′ and the extending sections 313 and 313′, and pass through the first surface 314 of the middle section, the inclined sections 311 and 311′, and the extending sections 313 and 313′, whereby the light sources are evenly dispersed outwardly. Eventually the evenly dispersed light sources penetrate through the first and the second annular light transmissive portions 111 and 121 to outside of the shell, as shown in FIG. 1.

Each light transmissive plate 31 has the middle section 312 and the inclined section 311 and 311′, and each luminous body faces to the middle section of corresponding light transmissive plate 31 direct, and the first surface 314 of the middle section is formed with the light reducing layer, whereby the evenly dispersed level of each light source is increased. As such, the light sources have been more even, soft and weak as they penetrate through the first and the second annular light transmissive portions 111 and 121. In other embodiments, inner surfaces or outer surfaces of the inclined sections or the extending sections also can be formed with a light reducing layer. In this way, the light sources are evenly dispersed much more.

Briefly, the light sources of the luminous bodies 32 direct illuminate the middle sections 312 of light transmissive plates which are in front of corresponding luminous bodies respectively. Although the light sources are strong, the light reducing layer is capable for weakening the intensities of the light sources and reflects a part of light sources. Thereafter a part of light sources move along the inclined sections to the extending sections. So the middle section and the extending sections adjacent to the middle section are planes and release evenly soft light sources that do not excite eyes of users at all.

The present invention is installed in the atomizer, and the light transmissive plates are disposed annularly in the luminous space. While users turn on the atomizer at nighttime, the first and the second light transmissive portions are bright and look like annular light circles. Due to the light sources are weak, soft and evenly dispersed, they are not only suitable for relaxation of bodies and minds of users, but create a romantic atmosphere.

What is claimed is:

1. A light dispersing device, comprising:
at least a light transmissive plate, comprising two inclined sections, a middle section and two extending sections, the inclined sections extending respectively from two ends of middle section outwardly and inclinedly, the extending sections extending respectively from one end of one of the inclined sections where being away from the middle section laterally, the middle section being located between the extending sections;
wherein the middle section has a first surface and a second surface, at least one of the first and the second surfaces is formed with a light reducing layer, the light reducing layer has properties of weakening the intensity of light sources and reflecting light sources;
at least an light-emitting diode luminous body, located at one side of the light transmissive plate and facing to the middle section of the light transmissive plate, an axis of the luminous body being perpendicular to the middle section of the light transmissive plate;
when light sources of the luminous body illuminating the middle section of the light transmissive plate perpendicularly, the intensities of light sources being weakened by the light reducing layer, and a part of light sources being reflected along the inclined sections to the extending sections, whereby the light sources are evenly dispersed outwardly.

2. The light dispersing device of claim 1, wherein the inclined sections and the middle section define a concave recess, the concave recess gradually broadens outwardly so that it is tapered.

3. The light dispersing device of claim 1, wherein the first surface of the middle section is formed with the light reducing layer, after a part of light sources pass through the second surface of the middle section, a part of light sources are reflected at least once by the light reducing layer, afterwards a part of light sources are reflected at least once by the middle section, the inclined sections and the extending sections, and pass through the first surface of the middle section, the inclined sections and the extending sections, whereby the light sources evenly dispersed outwardly.

4. The light dispersing device of claim 1, wherein the light reducing layer is a light diffusing agent.

5. The light dispersing device of claim 1, wherein the light reducing layer is a coating material.

6. The light dispersing device of claim 1, wherein the light reducing layer is a mask.

7. The light dispersing device of claim 1, further comprising a plurality of light-emitting diode luminous bodies, one of the extending sections of each light transmissive plate connecting to one of the inclined sections of another light transmissive plate, so that the luminous bodies being spaced successively and formed with a light transmissive ring.
